(19) United States
(12) Patent Application Publication
(10) Pub. No.: US 2020/0124114 A1
(43) Pub. Date: Apr. 23, 2020

(54) CLUTCH DEVICE FOR A DRIVETRAIN OF A VEHICLE

(71) Applicant: Schaeffler Technologies AG & Co. KG, Herzogenaurach (DE)

(72) Inventors: Martin Chambrion, Erstein (FR); Tim Schmid, Karlsruhe (DE)

(21) Appl. No.: 16/500,893

(22) PCT Filed: Apr. 25, 2018
(86) PCT No.: PCT/DE2018/100395

§ 371 Date: Oct. 4, 2019

(30) Foreign Application Priority Data
Apr. 27, 2017 (DE) 10 2017 109 096.7

(51) Int. Cl. F16D 13/56

(52) U.S. Cl. CPC F16D 13/56

(57) ABSTRACT

A clutch device for a drivetrain of a vehicle, has a first clutch component for introducing torque and a second clutch component for transmission of torque. The second clutch component is rotationally uncouplable from the first clutch component. First frictional elements of the first clutch component and second frictional elements of the second clutch component may be connectible so that they transmit torque. The partial self-amplification of the clutch device is executable here by the leaf spring unit, while the second spring unit exerts a static clamping force. The leaf spring unit and the second spring unit are rotationally uncoupled.

The present disclosure relates to a clutch device for a drivetrain of a vehicle, having a first clutch component for introducing torque and a second clutch component for transmission of torque, the second clutch component being rotationally uncouplable from the first clutch component, where first frictional elements of the first clutch component and second frictional elements of the second clutch component may be connectible so that they transmit torque.

### BACKGROUND

A clutch device of this species is known from WO 2014/139526 A1. The latter discloses a clutch device comprising an input side and an output side, which are arranged rotatably around an axis and have at least one first frictional partner and at least one second frictional partner, where the first frictional partner is connected torsionally to the input side, where the second frictional partner is connected torsionally to the output side, where the first and second frictional partners may be brought into frictional engagement by a clamping force in order to transmit torque between the input side and the output side, where at least one spring means is provided which amplifies the clamping force of the clutch device.

Such spring means are designed in general as leaf springs, which are able to produce an amplification of the clamping force due to their rise angle. In this case, the load on the leaf springs depends on the number of friction plates which transmit their torque through the leaf springs to a hub.

It is proposed in the as yet unpublished document DE 10 2016 207 116.5 that the number of friction surfaces which provide self-amplification of the clamping force be reduced. Although this measure greatly increases the robustness of the clutch device, the operating forces and the transmissible traction torques and drag torques still vary greatly over the life of the clutch device. These variations are mainly the consequence of the great rigidity of the leaf springs which are intended to provide the static clamping force, since the leaf springs are quite heavy.

From the likewise unpublished DE 10 2016 213 657.7 it is known that a partial self-amplification of the clutch is realizable by means of a leaf spring unit, while a second spring unit independent of the leaf spring unit exerts a static clamping force. By decoupling the production of the self-amplification only by the leaf spring unit, and by producing the static clamping force only by an independent spring unit, it is possible to reduce the weight of the clutch, since the number of leaf springs and thus the leaf spring stiffness is reduced, since only a partial amplification of the clamping force produced by the second spring unit occurs due to the leaf springs.

There, the second spring unit acts on the frictional elements of the clutch device through a disengaging plate. The leaf spring unit is connected on one side to the disengaging plate, and on the other side to a first hub. As a result of this linking of the leaf spring unit, the disengaging plate is moved relative to the first hub in a circumferential direction, that is, rotationally. At the same time, a rotational movement of the disengaging plate also occurs relative to the second spring unit. Specifically when the latter is designed as a diaphragm spring, the friction point existing between the diaphragm spring and disengaging plate may result in wearing of the affected individual parts.

Furthermore, the relative rotation of the disengaging plate and second spring unit produces a pronounced hysteresis in the operating procedure of the clutch device. This diminishes the operating convenience of the clutch device, since a driver feels greatly differing forces when engaging and disengaging the clutch.

### SUMMARY

Starting from that basis, an object of the present disclosure is to at least partially solve the problems known from the prior art. In particular, the intent is to specify a clutch device with which it is possible to retain the advantages of providing partial self-amplification and static clamping force independently of each other and increasing the operating convenience.

A clutch device for a drivetrain of a vehicle is proposed, having a first clutch component for introduction of torque and a second clutch component for transmission of torque, wherein the second clutch component is rotationally uncouplable from the first clutch component, wherein first frictional elements of the first clutch component and second frictional elements of the second clutch component are connectible so that they transmit torque, wherein a partial self-amplification of the clutch device is achievable by means of a leaf spring unit, while a second spring unit exerts a static clamping force; the leaf spring unit and the second spring unit are rotationally uncoupled.

The clutch device has an axis of rotation; at least some components of the clutch device are movable rotationally in a circumferential direction and toward each other in an axial direction along the axis of rotation.

Rotationally uncoupled means here in particular that a rotational movement of the leaf spring unit (it becomes longer or shorter in the circumferential direction when subjected to torque) is not transmitted (or only in small measure) to the second spring unit. In particular, this produces no rotation of the second spring unit relative to at least one tie-in point of the leaf spring unit, so that the hysteresis when the clutch device is actuated, and wearing of the clutch device, may at least be reduced.

In particular, a rise angle of the leaf springs of the leaf spring unit is between 40° and 55°. This relatively large rise angle of the leaf springs reduces the variation of the self-amplification, which prolongs the life of the leaf springs. This version is also advantageous in regard to the weight of the clutch device, since the leaf springs do not produce any static clamping force here. For example, three leaf spring assemblies of at least one individual leaf spring unit may be used, which results in a significant weight saving.

In particular, the second spring unit is designed as a diaphragm spring. Other types of springs may also be employed, however (for example compression springs, leaf springs, tension springs, torsion springs, conical springs, coil springs, elliptical springs).

In particular, the leaf spring unit is joined to a leaf spring core, and a specified first number of the second frictional elements of the second clutch component are connected rotationally to a hub through the leaf spring unit and the leaf spring core. A specified second number of the second frictional elements of the second clutch component are coupled rotationally with the hub through an inner plate carrier. The leaf spring core and the inner plate carrier are connected rotationally with one another, and uncoupled from one another in an axial direction. So the leaf spring core is in particular positioned movably relative to the inner plate carrier in the axial direction, while it is joined thereto in the circumferential direction (for example by a positive lock).

In particular, the second spring unit transmits the static clamping force through a disengaging plate to the frictional elements; the leaf spring unit is joined on one side to the leaf spring core and on the other side to a reinforcing plate (in each case at least one connecting point), so that the reinforcing plate is rotationally coupled with the specified first number of the second frictional elements. The reinforcing plate is connectible to the disengaging plate to transmit a leaf spring force acting in an axial direction; the disengaging plate is rotationally uncoupled from the reinforcing plate.

This rotational uncoupling of the disengaging plate from the reinforcing plate makes a (limited) relative rotation of the reinforcing plate relative to the disengaging plate possible, so that a rotational movement of the disengaging plate relative to the second spring unit may be prevented, or at least reduced.

In particular, the reinforcing plate is connected to the disengaging plate by means of at least one stepped bolt (for example three, universally distributed in the circumferential direction); the stepped bolt extends in the axial direction through an elongated hole in the disengaging plate, so that the stepped bolt is positioned movably with the reinforcing plate in a circumferential direction relative to the disengaging plate.

In this way, the elongated hole, interacting with the stepped bolt, makes the rotational uncoupling of the disengaging plate and reinforcing plate possible.

In particular, the stepped bolt has differing diameters (steps) in the axial direction. On the one hand, the leaf springs are fastened (free of play) to the reinforcing plate by the steps, while on the other hand the disengaging plate is positionable, for example, with play in the axial direction and relative to the reinforcing plate.

When the torque being transmitted is positive, for example, the reinforcing plate is moved by means of the leaf spring unit in the axial direction, in particular away from the disengaging plate, until the stepped bolt comes into contact with the disengaging plate (after getting past the play in the axial direction). Beyond this torque, the clamping force of the second spring unit is amplified. If the torque is negative, for example, the reinforcing plate is moved by means of the leaf spring unit in the opposite axial direction, to the disengaging plate. After the play in the axial direction has been surpassed, the leaf spring unit counteracts the spring force of the second spring unit, and thereby reduces the static clamping force.

The reinforcing plate preferably has on an external circumferential surface at least one driver tab (preferably a plurality thereof); the reinforcing plate is rotationally coupled through the at least one driver tab with the first number of second frictional elements.

In particular, the leaf spring core is rotationally coupled with the inner plate carrier by means of at least one bolt. This coupling is achieved in particular by a positive lock between bolt and leaf spring core, acting in the circumferential direction. In particular, the bolt has a conically shaped end, so that the leaf spring core is positionable relative to the bolt in a simple way.

In particular, by means of a support plate extending in an axial direction the second spring unit is supported with centering relative to an axis of rotation of the clutch device and is braced in the axial direction, the support plate being joined to the leaf spring core.

In particular, the support plate extends in the axial direction through the disengaging plate and the second spring unit (in particular if the latter is in the form of a diaphragm spring); disengaging plate and second spring unit are thus rotationally couplable with one another. This makes it possible to also completely prevent opposing rotation of disengaging plate and second spring unit in the circumferential direction.

In particular the support plate extends in the axial direction, also through the reinforcing plate; here a rotation of the reinforcing plate relative to the support plate in the circumferential direction is enabled.

In particular, the first number of the second frictional elements comprises at least two frictional elements (but three or more of the second frictional elements may also be rotationally coupled with the leaf spring unit).

Let it be noted, as a precaution, that the ordinal numbers (“first,” “second,” . . . ) used here serve primarily (only) to differentiate among a plurality of similar objects, values or processes, so that in particular they do not necessarily indicate any dependence and/or sequential order of these objects, values or processes relative to each other. If a dependence and/or sequential order should be necessary, that must be stated here specifically or must be obvious to a person skilled in the art when studying the concretely described design.

### BRIEF SUMMARY OF THE DRAWINGS

The present disclosure as well as the technical environment will be explained in greater detail below on the basis of the figures. It should be pointed out that the invention is not to be limited by the exemplary embodiments shown. In particular, it is also possible, unless explicitly shown otherwise, to extract partial aspects of the circumstances explained in the figures and to combine them with other components and insights from the present description and/or figures. In particular, it must be pointed out that the figures, and especially the depicted size proportions, are only schematic. Like reference labels designate like objects, so that explanations from other figures may be cited in addition, as appropriate. The figures show the following:

FIG. 1: a known clutch device in perspective cross section;

FIG. 2: a clutch device in perspective cross section;

FIG. 3: a reinforcing plate of the clutch device according to FIG. 2 in perspective view.

FIG. 4: a detail from FIG. 2 in perspective cross section;

FIG. 5: a perspective view of the clutch device according to FIG. 2 without friction plates;

FIG. 6: a part of the clutch device according to FIG. 2 in perspective cross section; and

FIG. 7: another part of the clutch device according to FIG. 2 in perspective cross section.

### DETAILED DESCRIPTION

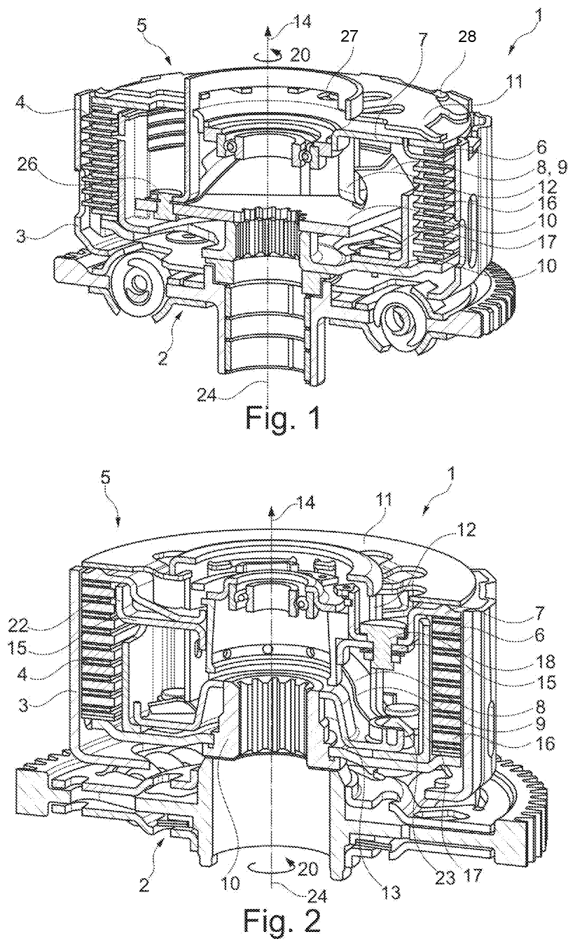

FIG. 1 shows a clutch device 1 in perspective cross section. The clutch device 1 has a first clutch component 2, which is connectible to a crankshaft of a combustion engine to provide an indirect or direct rotary connection. The first clutch component 2 has a sleeve-shaped outer plate carrier 3, which is coupled rotationally by means of its radial inner surface to a plurality of first frictional elements in the form of first friction plates 4 (so that it forms a positive lock).

Along with the first clutch component 2, the clutch device 1 includes a second clutch component 5, which is coupled rotationally with additional frictional elements in the form of second friction plates 6, 16 (so that it forms a positive lock). The first clutch component 2 is rotationally uncoupled from the second clutch component 5, or connected to the latter non-rotatingly by means of the friction plates 4, 6, 16, depending on the position of the clutch device 1.

The first friction plates 4 of the first clutch component 2 and the second friction plates 6, 16 of the second clutch component 5 are arranged in the axial direction 14 so that between each two adjacent first friction plates 4 in principle a second friction plate 6, 16 of the second clutch component 5 is always positioned. The friction plates 4, 6, 16 are all movable in the axial direction 14 relative to each other. When the clutch device 1 is in the engaged position, the first and second friction plates 4, 6, 16 are connected non-rotatingly with one another and frictionally locked by means of an applied connecting force in the form of the axial clamping force which is produced by a second spring unit 11 in the form of a diaphragm spring. When the clutch device 1 is in the disengaged position, the first and second friction plates 4, 6, 16 are again positioned without force relative to each other, and thus are rotatable relative to each other.

The second clutch component 5 has a disengaging plate 7, which is connected non-rotatingly to a leaf spring unit 8. The leaf spring unit 8 is formed, for example, by a plurality of leaf spring assemblies 9 distributed in the circumferential direction 20 of the clutch device 1, each leaf spring assembly 9 consisting of a plurality of individual leaf springs sandwiched or laid flat on top of one another. One end of the leaf spring assembly 9 is connected non-rotatingly to the disengaging plate 7 at a connecting point 26 by means of a riveted connection. At the other end, each leaf spring assembly 9 is connected to a hub 10 at a connecting point 26 by means of another riveted connection. The hub 10 is connected non-rotatingly to a transmission shaft, not shown in further detail here.

The diaphragm spring 11 is supported and centered on the disengaging plate 7 by means of a support plate 12 extending axially, while protrusions of the support plate 12 engage the radially extending diaphragm spring 11. A lower support of the diaphragm spring 11 is provided by tongues 27, 28 integrated into the respective inner and outer circumference of the diaphragm spring 11, which are located outside of the force rim of the diaphragm spring 11. This special type of support makes it possible to actuate the diaphragm spring 11 beyond the flat position, which contributes to elastic support of the diaphragm spring 12.

Tabs of a first number of second friction plates 6 of the second clutch component 5 mesh with the disengaging plate 7 from below. These tabs are bent axially opposite the radially extending second friction plates 6, and make it possible to center the second friction plates 6 relative to the disengaging plate 7 and realize the driving of the torque transmitted by the first clutch component 2. The leaf spring unit 8 passes the torque absorbed from the second clutch component 5 on to the transmission input shafts by means of three first friction surfaces of the respective second friction plate 6, whereby a self-amplification of the clamping force produced by the second spring unit 11 is realized. Since the torque is transmitted to the leaf spring unit 8 by only a limited number of second friction plates 6 of the second clutch component 5, the leaf spring unit 8 thus performs a partial self-amplification of the clamping force of the second spring unit 11.

The remaining second friction plates 16 of the second clutch component 5 are connected to an inner plate carrier 17. The inner plate carrier 17 is riveted to a hub 10, while this hub 10 is also connected to the transmission input shaft. This results in a direct coupling of the torque transmitted from the first clutch component 2 to the second clutch component 5, to the transmission input shaft.

In this clutch device 1, the second spring unit 11 acts through a disengaging plate 7 on the friction plates 4, 6, 16 of the clutch device 1. The leaf spring unit 8 is connected on one side to the disengaging plate 7, and on the other side to the first hub 10. As a result of this linking of the leaf spring unit 8, the disengaging plate 7 is moved relative to the hub 10 in a circumferential direction 20, that is, rotationally. At the same time, a rotational movement of the disengaging plate 7 also occurs relative to the second spring unit 11.

FIG. 2 shows a clutch device 1 in perspective cross section. The clutch device 1 comprises a first clutch component 2 for introduction of torque and a second clutch component 5 for transmission of torque, wherein the second clutch component 5 is rotationally uncouplable from the first clutch component 2, wherein first frictional elements 4 of the first clutch component 2 and second frictional elements 6, 16 of the second clutch component 5 are connectible so that they transmit torque, wherein a partial self-amplification of the clutch device 1 is achievable by means of a leaf spring unit 8, while a second spring unit 11 exerts a static clamping force; the leaf spring unit 8 and the second spring unit 11 are rotationally uncoupled.

The clutch device 1 has an axis of rotation 24; at least some components of the clutch device 1 are movable rotationally in a circumferential direction 20 and toward each other in an axial direction 14 along the axis of rotation 24. The second spring unit 11 is designed as a diaphragm spring.

The leaf spring unit 8 is joined to a leaf spring core 13, and a specified first number of the second frictional elements 6 of the second clutch component 5 are connected rotationally to the hub 10 through the leaf spring unit 8 and the leaf spring core 13. A specified second number of the second frictional elements 16 of the second clutch component 5 are coupled rotationally with the hub 10 through an inner plate carrier 17. The leaf spring core 13 and the inner plate carrier 17 are connected rotationally with one another, and uncoupled from one another in an axial direction 14. So the leaf spring core 13 is positioned movably relative to the inner plate carrier 17 in the axial direction 14, while it is joined thereto in the circumferential direction 20 by a positive lock.

The second spring unit 11 transmits the static clamping force through a disengaging plate 7 to the friction plates 4, 6, 16; the leaf spring unit 8 is joined on one side to the leaf spring core 13 and on the other side to a reinforcing plate 15 (in each case at at least one connecting point 16), so that the reinforcing plate 15 is rotationally coupled with the specified first number of the second frictional elements 6. The reinforcing plate 15 is connectible to the disengaging plate 7 to transmit a leaf spring force acting in an axial direction 14; the disengaging plate 7 is rotationally uncoupled from the reinforcing plate 15.

This rotational uncoupling of the disengaging plate 7 from the reinforcing plate 15 makes a (limited) relative rotation of the reinforcing plate 15 relative to the disengaging plate 7 possible, so that a rotational movement of the disengaging plate 7 relative to second spring unit 11 may be prevented, or at least reduced.

A rotational movement of the leaf spring unit 8 (it becomes longer or shorter in the circumferential direction 20 when subjected to torque) is thus not transmitted to the second spring unit 11 here. No rotation of the second spring unit 11 occurs here relative to at least one tie-in point 26 of the leaf spring unit 8 on the reinforcing plate 15, so that the hysteresis when the clutch device 1 is actuated, and wearing of the clutch device 1, may at least be reduced.

The reinforcing plate 15 is connected to the disengaging plate 7 by means of stepped bolts 18; the stepped bolt 18 extends in the axial direction 14 through an elongated hole 19 in the disengaging plate 7, so that the stepped bolt 18 is positioned movably with the reinforcing plate 15 in a circumferential direction 20 relative to the disengaging plate 7.

In this way, the elongated hole 19, interacting with the stepped bolt 18, makes rotational uncoupling of disengaging plate 7 and reinforcing plate 15 possible.

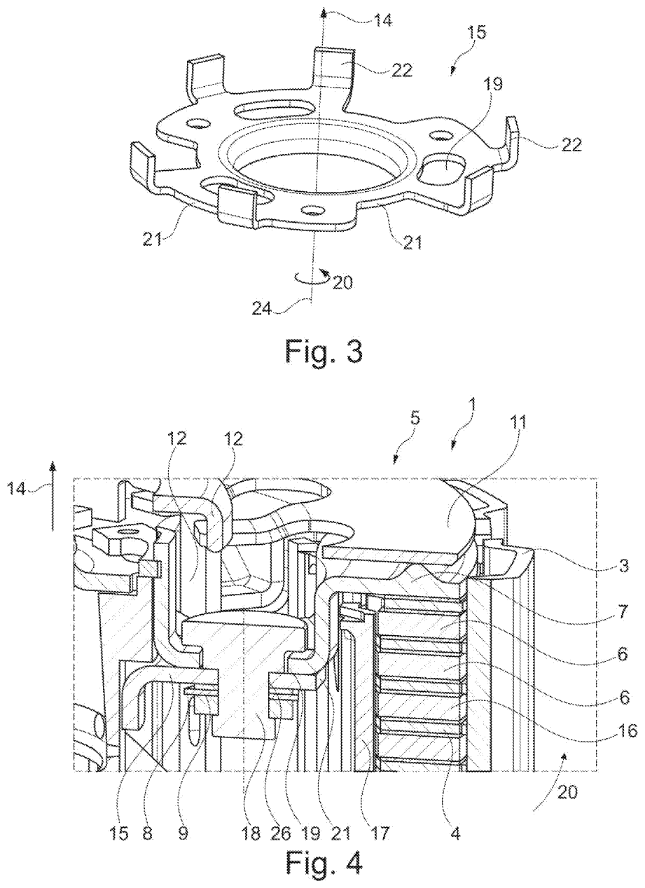

FIG. 3 shows a reinforcing plate 15 of the clutch device 1 according to FIG. 2 in perspective view. The reinforcing plate 15 has a plurality of elongated holes 19, through which the stepped bolts 18 extend when the reinforcing plates are in the installed state. The reinforcing plate 15 has a plurality of driver tabs 22 on an outer circumferential surface 21; the reinforcing plate 15 is rotationally coupled with the first number of the second frictional elements 6 by means of the driver tabs 22.

FIG. 4 shows a detail from FIG. 2 in perspective cross section. See the comments on FIGS. 2 and 3. The stepped bolt 18 has differing diameters (steps) in the axial direction 14. On the one hand, the leaf springs are fastened (free of play) to the reinforcing plate 15 by the steps, while on the other hand the disengaging plate 7 is positionable with play in the axial direction 14 and relative to the reinforcing plate 15.

When the torque being transmitted is positive, the reinforcing plate 15 is moved by means of the leaf spring unit 8 in the axial direction 14 away from the disengaging plate 7, until the stepped bolt 18 comes into contact with the disengaging plate 7 (after surpassing the perceptible play in the axial direction 14). Beyond this torque, the clamping force of the second spring unit 11 is amplified. If the torque is negative, the reinforcing plate 15 is moved by means of the leaf spring unit 8 in the opposite axial direction 14, to the disengaging plate 7. After the play in the axial direction 14 has been surpassed, the leaf spring unit 8 counteracts the spring force of the second spring unit 11, and thereby reduces the static clamping force.

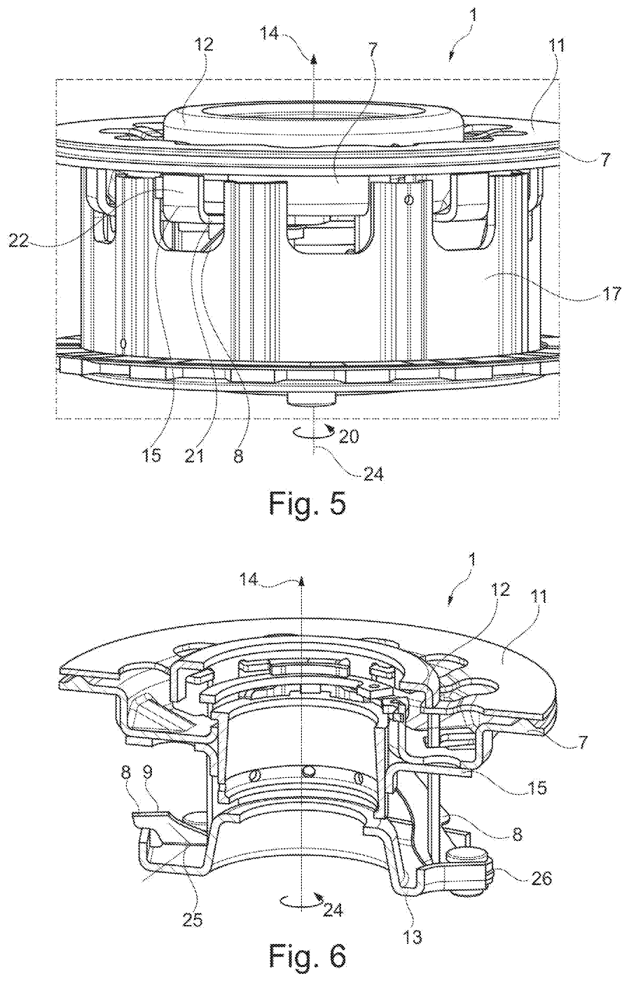

FIG. 5 shows a perspective view of the clutch device 1 according to FIG. 2 without friction plates 4, 6, 16 and without an outer plate carrier 3. See the comments on FIGS. 2 through 4.

Depicted here is the inner plate carrier 17 with the reinforcing plate 15, the disengaging plate 7 and the second spring unit 11. The partial self-amplification of the clutch device 1 is executable by means of the leaf spring unit 8, while the second spring unit 11 exerts a static clamping force; the leaf spring unit 8 and the second spring unit 11 are rotationally uncoupled.

FIG. 6 shows a part of the clutch device 1 according to FIG. 2 in perspective cross section. See the comments on FIGS. 2 through 5.

It can be seen that the support plate 12 extends in the axial direction 14 through the disengaging plate 7 and the second spring unit 11, with the disengaging plate 7 and the second spring unit 11 being rotationally coupled with one another. This makes it possible to completely prevent opposing rotation of disengaging plate 7 and second spring unit 11 in the circumferential direction 20. The support plate 12 extends in the axial direction 14, also through the reinforcing plate 15; a rotation of the reinforcing plate 15 relative to the support plate 12 in the circumferential direction 20 is enabled. By means of the support plate 12 extending in the axial direction 14 the second spring unit 11 is supported with centering relative to an axis of rotation 24 of the clutch device 1 and is braced in the axial direction 14, the support plate 12 being joined to the leaf spring core 13 at the connecting points 26 of the leaf spring unit 8.

The leaf spring unit 8 is fastened to the leaf spring core 13 by means of the connecting points 26. A rise angle 25 of the leaf spring assembly 9 of the leaf spring unit 8 is between 40° and 55°. This relatively large rise angle of the leaf springs reduces the variation of the self-amplification, which prolongs the life of the leaf springs. This version is also advantageous in regard to the weight of the clutch device 1, since the leaf spring unit 8 does not produce any static clamping force here.

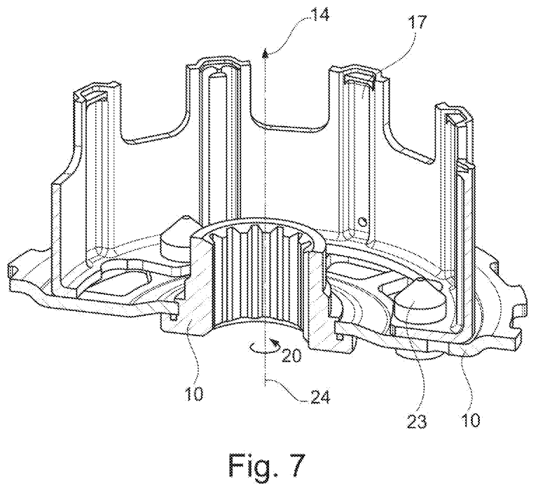

FIG. 7 shows another part of the clutch device 1 according to FIG. 2 in perspective cross section. See the comments on FIGS. 2 through 6. The inner plate carrier 17 is connected torsionally to the hub 10 by means of the bolts 23. These bolts 23 rotationally couple the leaf spring core 13 with the inner plate carrier 17. This coupling is achieved by a positive lock between bolt 23 and leaf spring core 13 acting in the circumferential direction 20 (see FIG. 2). The bolt 23 has a conically shaped end, so that the leaf spring core 13 is positionable relative to the bolt 23 in a simple way.

### REFERENCE LABELS

1 clutch device
2 first clutch component
3 outer plate carrier
4 first friction plate
5 second clutch component
6 second friction plate (first number)
7 disengaging plate
8 leaf spring unit
9 leaf spring assembly
10 hub
11 second spring unit
12 support plate
13 leaf spring core
14 axial direction
15 reinforcing plate
16 second friction plate (second number)
17 inner plate carrier
18 stepped bolt
19 elongated hole
20 circumferential direction
21 outer circumferential surface
22 driver tab
23 bolt
24 axis of rotation
25 rise angle
26 connecting point
27, 28 tongues

1-10. (canceled)

11. A clutch device for a drivetrain of a vehicle comprising:
a first clutch component for introduction of torque;
a second clutch component for transmission of torque, the second clutch component being rotationally uncouplable from the first clutch component, first frictional elements of the first clutch component and second frictional elements of the second clutch component being connectible so that the first frictional elements and the second frictional elements transmit torque;
a leaf spring unit; and
a second spring unit, the leaf spring unit being configured for achieving a partial self-amplification of the clutch device, while a second spring unit exerts a static clamping force, the leaf spring unit and the second spring unit being rotationally uncoupled.

12. The clutch device according to claim 11, wherein the second spring unit is a diaphragm spring.

13. The clutch device according to claim 11, wherein the leaf spring unit is joined to a leaf spring core, a specified first number of the second frictional elements of the second clutch component being rotationally connected to a hub by the leaf spring unit and the leaf spring core, a specified second number of the second frictional elements of the second clutch component being rotationally coupled with the hub by an inner plate carrier, the leaf spring core and the inner plate carrier being rotationally coupled and being uncoupled from one another in an axial direction.

14. The clutch device according to claim 13, wherein the second spring unit transmits the static clamping force to the first frictional elements and the second frictional elements by a disengaging plate, the leaf spring unit being connected on one side to the leaf spring core and on the other side to a reinforcing plate so that the reinforcing plate is rotationally coupled with the specified first number of the second frictional elements, the reinforcing plate being connectible with the disengaging plate to transmit a leaf spring force operating in the axial direction, the disengaging plate being rotationally uncoupled from the reinforcing plate.

15. The clutch device according to claim 14, wherein the reinforcing plate is connected to the disengaging plate by at least one stepped bolt, the stepped bolt extending in the axial direction through an elongated hole in the disengaging plate so that the stepped bolt is positioned movably with the reinforcing plate in a circumferential direction relative to the disengaging plate.

16. The clutch device according to claim 14, wherein the reinforcing plate has on an external circumferential surface at least one driver tab, the reinforcing plate being rotationally coupled through the at least one driver tab with the specified first number of second frictional elements.

17. The clutch device according to claim 13, wherein the leaf spring core is rotationally coupled with the inner plate carrier by at least one bolt.

18. The clutch device according to claim 13, wherein the second spring unit is supported by a support plate extending in the axial direction with centering relative to an axis of rotation of the clutch device and is braced in the axial direction, the support plate being joined to the leaf spring core.

19. The clutch device according to claim 13, wherein the first specified number of the second frictional elements comprises at least two of the second frictional elements.

20. The clutch device according to claim 11, wherein a rise angle of the leaf springs of the leaf spring unit is between 40° and 55°.

21. A method of constructing a clutch device for a drivetrain of a vehicle comprising:
arranging a first clutch component for introduction of torque with respect to a second clutch component for transmission of torque such that first frictional elements of the first clutch component and second frictional elements of the second clutch component are rotationally couplable to each other and rotationally uncouplable from each other; and
providing a leaf spring unit for achieving a partial self-amplification of the clutch device and providing a second spring unit for exerting a static clamping force such that the leaf spring unit and the second spring unit being are rotationally uncoupled.

22. A clutch device for a drivetrain of a vehicle comprising:
a first clutch component for introduction of torque, the first clutch component including first frictional elements;
a second clutch component for transmission of torque, the second clutch component including second frictional elements, the first frictional elements and the second frictional elements being rotationally couplable to each other being rotationally uncouplable from each other;
a first spring unit connected non-rotatably to the second clutch component and configured for transferring the torque via a first subset of the second frictional elements from the second clutch component to a transmission output hub; and
a second spring unit configured for exerting a static clamping force on the second clutch component, the first spring unit and the second spring unit being rotationally uncoupled.

23. The clutch device as recited in claim 22 wherein the second clutch component includes a plate carrier configured for transferring the torque via a second subset of the second frictional elements from the second clutch component to the transmission output hub.

24. The clutch device according to claim 22 further comprising a disengaging plate configured for transmitting the static clamping force from the second spring unit to the first frictional elements and the second frictional elements.

25. The clutch device according to claim 22 further comprising a reinforcing plate rotationally coupled with the first subset of the second frictional elements.

26. The clutch device according to claim 25, the reinforcing plate being connectible with the disengaging plate to transmit a leaf spring force operating in the axial direction, the disengaging plate being rotationally uncoupled from the reinforcing plate.
